(19) United States
(12) Patent Application Publication
(10) Pub. No.: US 2009/0001218 A1
(43) Pub. Date: Jan. 1, 2009

(54) Stifffened multispar torsion box

(75) Inventors: Maria Pilar Munoz Lopez, Madrid (ES); Francisco Jose Cruz Dominguez, Madrid (ES)

Correspondence Address: LADAS & PARRY LLP, 26 WEST 61ST STREET, NEW YORK, NY, 10023, US

(73) Assignee: AIRBUS ESPANA, S.L.

(21) Appl. No.: 11/897,029

(22) Filed: Aug. 28, 2007

(30) Foreign Application Priority Data
Jun. 28, 2007 (ES) 200701810

(51) Int. Cl. B64C 3/18

(52) U.S. Cl. 244/124

(57) ABSTRACT

The invention relates to an integrated structure of a composite material multispar torsion box (1) for aircraft, comprising a lower skin (12), an upper skin (11), several spars (9) defining cells (14), the first cell (19) being the closest to the input of load in the box (1), said structure comprising unit elements in the first cell, which unit elements provide the torsion box (1) with the necessary torsional rigidity to prevent the deformations occurring as a result of local loads.

### FIELD OF THE INVENTION

The present invention relates to a structure of a stiffened multispar torsion box for aeronautical structures with supporting surfaces.

### BACKGROUND OF THE INVENTION

It is commonly known that the aeronautical industry requires structures which on one hand can support the loads to which they are subjected, complying with high strength and rigidity requirements, and on the other hand are as light as possible. A result of this requirement is the increasingly extended use of composite materials in primary structures, which, well applied, can involve an important weight saving compared to metallic design.

Integrated structures have especially proved to be efficient in this sense. An structure is referred to as integrated when the different structural elements subjected to different stress (shearing stress, normal stress, etc.) are manufactured simultaneously or come from one and the same part. This is another advantage of the use of composite materials, which due to their condition of independent layers which can be stacked in the desired manner, offer the possibility of integrating the structure more and more, which furthermore often causes a cost saving, which is equally essential while competing in the market, as there are less individual parts to be assembled.

In addition, a very integrated structure also involves a series of drawbacks which have to be solved to complete its efficiency. One of them is the little accessibility for assembling the elements in the inside which cannot be integrated, such as the specific system supports, equipment and elements for locally transmitting concentrated loads and optimizing the structure.

There have recently been great efforts to achieve an increasingly higher level of integration in the production of wings in composite material.

The main structure of supporting surfaces of airplanes is formed by a leading edge, a torsion box and a trailing edge. The torsion box is a typical structure formed by an upper panel and a lower panel with thin walls, and front and rear spars. Other structural elements such as ribs, additional spars and longitudinal or transverse stiffening elements can also be found inside the torsion box in some of these components.

Depending on the structural, manufacturing, maintenance and certification requirements etc., all these elements may or may not be essential and may be more or less effective.

The currently most used structure for a torsion box is internally formed by several transverse ribs between the front and rear spars, the main functions of which ribs are: providing torsional rigidity, longitudinally limiting the skins and the stringers so as to discretize the buckling loads, maintaining the shape of the aerodynamic surface and supporting local load introductions resulting from actuator fittings, support bearings and similar devices which are directly secured to the rib.

Another structural concept of a torsion box is the “multispar”, where the ribs are dispensed with and several spars are introduced. These inner spars can comply with some of the functions that the ribs carry out in the first concept, however, the issue of transmitting very concentrated transverse loads in the support points dispensing with an actual rib is still to be solved, this aspect being necessary given that the pure multispar structure tends to be deformed as a result of the torsion caused by these transverse loads.

As has been mentioned, the multipar box concept as such does not have much torsional rigidity. It is therefore necessary to optimize the structure in this sense so that it works efficiently, with the additional difficulty that there is little accessibility to later carry out the assembly operations if the structure has been highly integrated.

Innovative design concepts to solve this issue are the object of the present invention.

### SUMMARY OF THE INVENTION

The present invention therefore relates to several counter-fitting design concepts to reinforce structures of multispar torsion boxes, where the lack of actual ribs makes local inputs of load difficult. The main field of application of the invention is that of aeronautical structures with supporting surfaces, although the invention can also be applied to other structures with similar features.

The aim of this invention is the design of structural elements in concentrated load introduction points for a torsion box without ribs. These elements will provide the necessary torsional rigidity to prevent the deformations occurring as a result of local loads resulting from securing and supporting fittings, supports, etc.

Other features and advantages of the present invention will be understood from the following detailed description of an illustrative embodiment of its object in relation to the attached figures.

### DESCRIPTION OF THE DRAWINGS

FIG. 1 shows the torsion box of the horizontal stabilizer of a commercial airplane with a typical known multirib structure.

FIG. 2 shows the known configuration of a torsion box in which the supports and fittings are directly joined to the rings, where the rigidity of the structure is maximum.

FIG. 3 shows the inside of the wing of a military airplane, with a known structure of a multispar torsion box.

FIG. 4 schematically shows a cross-section of the multispar structure of a torsion box and the resulting deformation due to typical known loads.

FIG. 5a shows an assembly of angle brackets for stiffening the structure under torsion of a multispar torsion box according to a first embodiment of the present invention.

FIG. 5b shows an assembly of angle brackets combined with diagonal bars for stiffening the structure under torsion of a multispar torsion box according to a first embodiment of the present invention.

FIG. 6a shows an example of counter-fittings with a two-sided joint for stiffening the structure under torsion of a multispar torsion box according to a second embodiment of the present invention.

FIG. 6b shows an example of counter-fittings with a single-sided joint combined with angle bars for stiffening the structure under torsion of a multispar torsion box according to a first embodiment of the present invention.

FIG. 7 shows the arrangement of the assembly of angle brackets for stiffening the structure under torsion of a multispar torsion box according to a first embodiment of the present invention.

FIG. 8 shows the arrangement of the assembly of angle brackets combined with diagonal bars for stiffening the structure under torsion of a multispar torsion box according to a first embodiment of the present invention.

FIG. 9 shows the arrangement of counter-fittings with a two-sided joint for stiffening the structure under torsion of a multispar torsion box according to a second embodiment of the present invention.

### DETAILED DESCRIPTION OF THE INVENTION

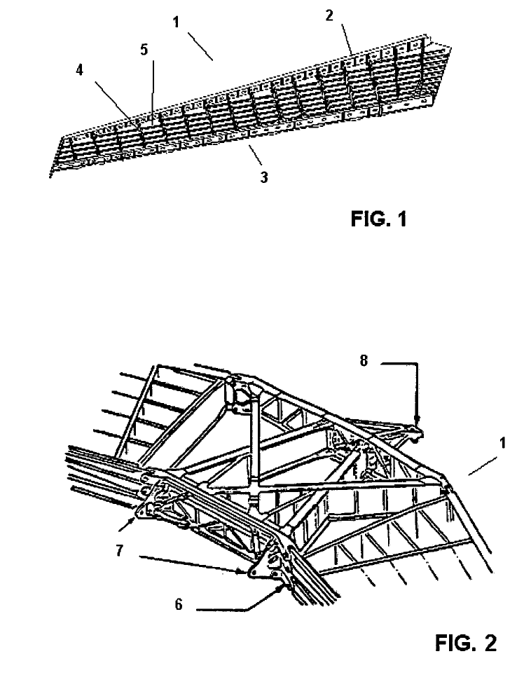

As seen in FIG. 1, the currently most used structure for a torsion box 1 is internally formed by several transverse ribs 4 between the front 2 and rear 3 spars, the main functions of which ribs are: providing torsional rigidity, longitudinally limiting the skins and the stringers 5 so as to discretize the buckling loads, maintaining the shape of the aerodynamic surface and supporting local load introductions resulting from stabilizing devices 6, longitudinal linkage supports 7 and support screws 8, which are directly secured to the ribs 4 (FIG. 2)

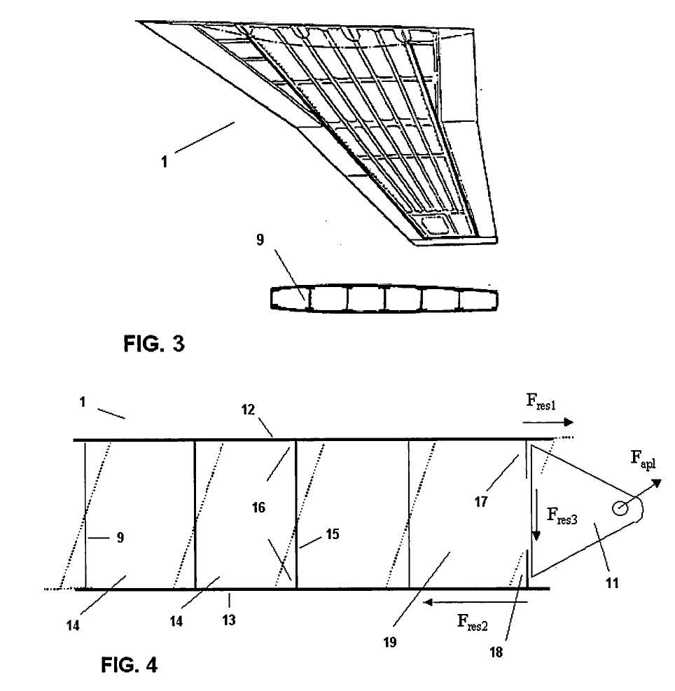

Another structural concept of a torsion box is the “multispar”, as shown in FIG. 3, where the ribs 4 are initially dispensed with and several spars 9 are introduced. These inner spars can comply with some of the functions that the ribs 4 carry out in the first concept (FIGS. 1 and 2), however, the issue of transmitting very concentrated transverse loads in the support points dispensing with an actual rib 4 is still to be solved, this aspect being necessary given that the pure multispar structure tends to be deformed as a result of the torsion caused by these transverse loads.

The aim of this invention is therefore the design of structural elements in concentrated load introduction points for a torsion box 1 without ribs 4. These structural elements provide the torsion box 1 with the necessary torsional rigidity to prevent the deformations occurring as a result of local loads resulting from securing and supporting fittings 11, supports, etc.

The multispar 9 torsion box 1 on which the present invention is based is formed by the upper 12 and lower 13 skins, which are the elements closing the box 1 at the upper and lower part, and are characterized by mainly supporting compression-traction and shear loads, Fᵣₑₛ₁, Fᵣₑₛ₂, Fᵣₑₛ₃, in the plane. Stringers 17, 18 have been introduced to achieve sufficient rigidity of the cells 14 of the torsion box 1 and to stabilize them against buckling, without increasing their thickness. The stringers 17, 18 also assume part of the longitudinal flows resulting from bending moments.

In addition, there are multiple spars 9 which, like skins 12 and 13, are typical thin-walled structures. They must mostly support bending and torsion loads. In a simplified manner, the resulting shear flows must be supported by the web 15 of the spar 9, whereas the legs 16 or chords of the spars 9 must support the traction and compression loads resulting from the bending of the torsion box 1.

Therefore, from the structural point of view, the box 1 is formed by:
Lower skin 13
Upper skin 12
Several spars 9, which are in turn formed by:
   Chord 16
   Web 15
Several stringers 17 in the upper skin 12
Several stringers 18 in the lower skin.

When such a structure 1 is subjected to eccentric transverse loads Fₐₚₗ tends to be deformed as shown in FIG. 4. This situation of stress is a typical case in supporting surfaces of aircraft. A traditional rib 4 in these most critical areas would be a way of providing more rigidity and preventing inadmissible deformations, but since the structure 1 is closed, this would not be possible if the rib 4 has not been initially integrated, which makes the whole manufacture of the box 1 enormously difficult.

One solution to this drawback is to introduce unit elements in the first cell 19, this cell 19 being the cell that is closest to the input of load Fₐₚₗ, which cell is open at one side to enable the assembly (see FIG. 4). These unit elements must be sufficiently small so that they can later be assembled in the cell 19, while at the same tome they must increase the torsional rigidity of the multispar box.

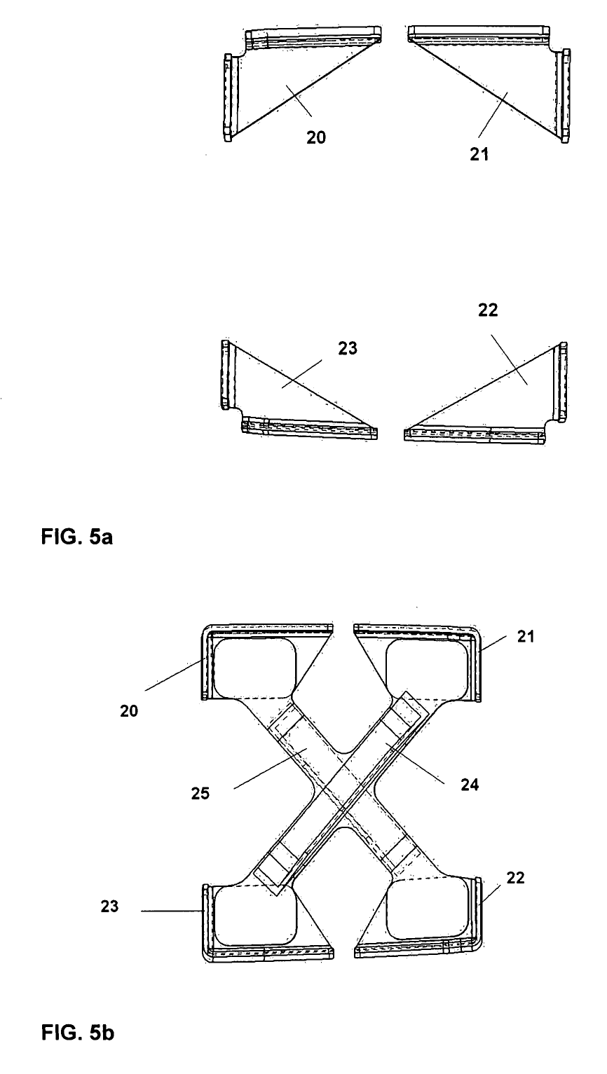

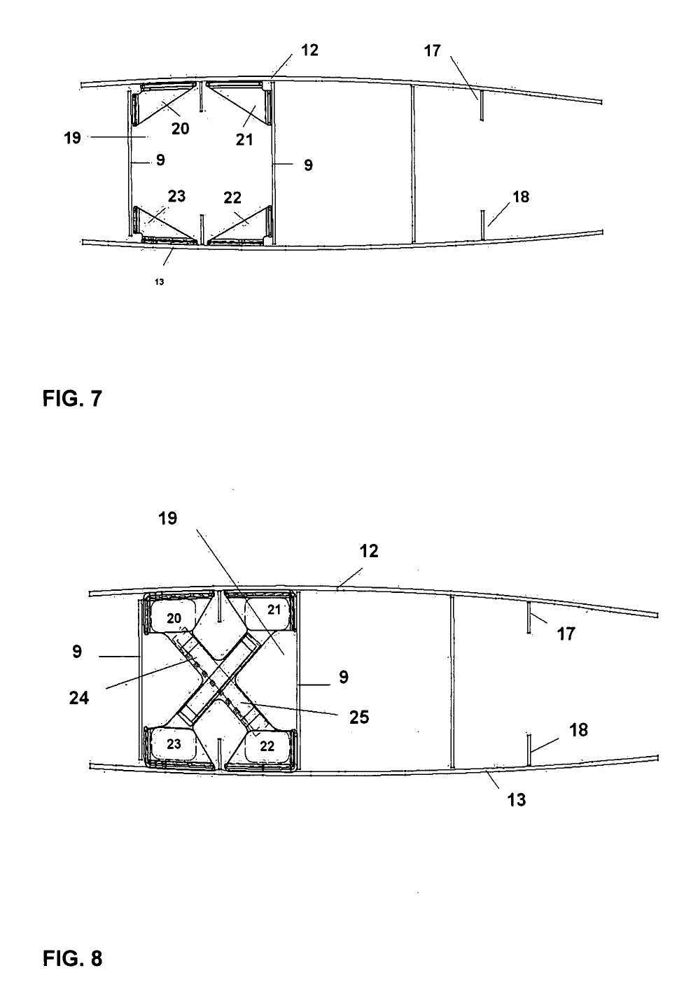

The first embodiment according to the invention comprises an angle bracket 20, 21, 22 and 23, in each corner of the first cell 19 and two bars 24 and 25 joining the angle brackets 20, 21, 22 and 23 diagonally. The side of the first cell 19 is later closed after carrying out the necessary assembly work. It is possible to dispense with the diagonal bars 24 and 25 if they are not necessary (FIG. 5a), and both bars 24 and 25 can be designed as a single part to minimize the total number of parts (FIG. 5b). The previous placement can be seen in FIGS. 7 and 8.

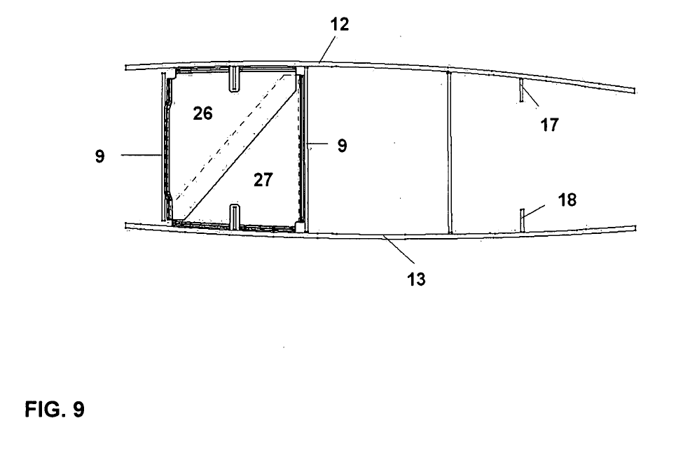

The second embodiment according to the invention includes two alternatives of counter-fittings 26 and 27, and counter-fittings 28 and 29, combined with angle bars 30. With this latter embodiment, comprising counter-fittings 28 and 29 combined with angle bars 30, the total number of parts increases but two-sided joints are prevented, which make the assembly difficult and frequently make it necessary to supplement for meeting the engineering requirements, thus making the product expensive. The placement of counter-fittings can be seen in FIG. 9.

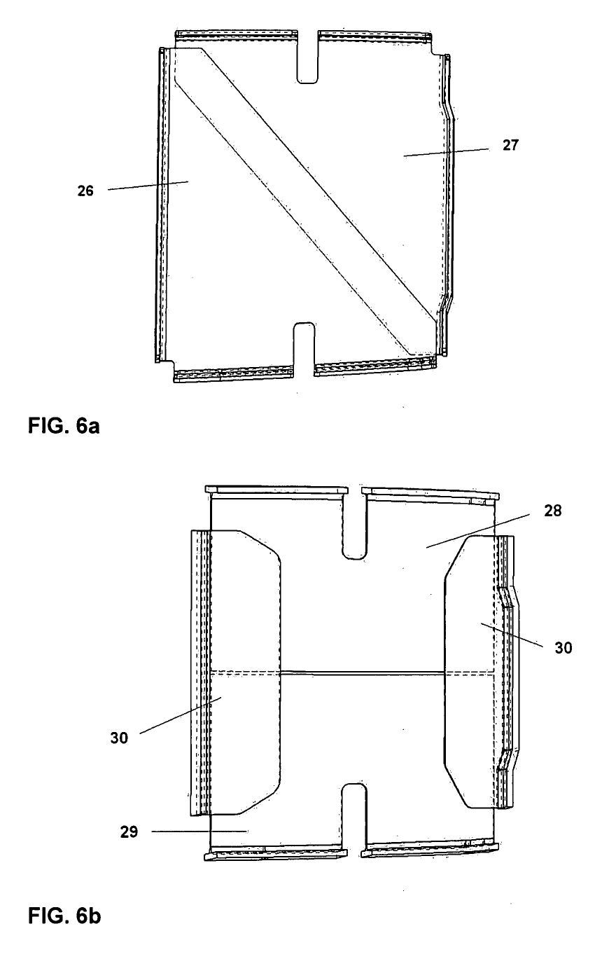

The assembly shown in FIG. 6a comprises two counter-fittings 26 and 27 joined to one another diagonally, each of them being joined to a skin, upper skin 12 and lower skin 13, and to a spar 9 (two-sided joint). FIG. 6b shows an example in which the two-sided joint is prevented, increasing the number of parts, because counter-fittings 28 and 29 combined with angle bars 30 are used. The number of parts will always depend on the rigidity required in each case.

The modifications described within the scope defined by the following claims can be introduced in the embodiments which have just been described.

1. An integrated structure of a composite material multispar torsion box (1) for aircraft, comprising a lower skin (12), an upper skin (11), several spars (9) defining cells (14), the first cell (19) being the closest to the input of load in the box (1), characterized in that it comprises an angle bracket (20, 21, 22, 23) in each corner of the first cell (19), which angle brackets provide the torsion box (1) with the necessary torsional rigidity to prevent the deformations occurring as a result of local loads.

2. An integrated structure of a composite material multispar torsion box (1) for aircraft according to claim 1, characterized in that it comprises two bars (24, 25) joining the angle brackets (20, 21, 22, 23) diagonally.

3. An integrated structure of a composite material multispar torsion box (1) for aircraft according to claim 2, characterized in that the bars (24, 25) joining the angle brackets (20, 21, 22, 23) diagonally are formed by a single part.

4. An integrated structure of a composite material multispar torsion box (1) for aircraft, comprising a lower skin (12), an upper skin (11), several spars (9) defining cells (14), the first cell (19) being the closest to the input of load in the box (1), characterized in that it comprises two counter-fittings (26, 27) joined to one another diagonally, each of them being joined to a skin (12, 13) and to a spar (9) in the first cell (19) of the torsion box (1) which provide the torsion box (1) with the necessary torsional rigidity to prevent the deformations occurring as a result of local loads.

5. An integrated structure of a composite material multispar torsion box (1) for aircraft, comprising a lower skin (12), an upper skin (11), several spars (9) defining cells (14), the first cell (19) being the closest to the input of load in the box (1), characterized in that it comprises two counter-fittings (28, 29) combined with angle bars (30) in the first cell (19) of the torsion box (1) which provide the torsion box (1) with the necessary torsional rigidity to prevent the deformations occurring as a result of local loads.
